(19) United States
(12) Patent Application Publication
(10) Pub. No.: US 2025/0137840 A1
(43) Pub. Date: May 1, 2025

(54) Vibration Sensor and Dog Bark Detection Device

(71) Applicant: Sheng Chen, Ningbo (CN)

(72) Inventor: Sheng Chen, Ningbo (CN)

(21) Appl. No.: 18/384,887

(22) Filed: Oct. 30, 2023

(51) Int. Cl. G01H 11/06

(52) U.S. Cl. CPC G01H 11/06

(57) ABSTRACT

The present invention provides a vibration sensor, comprising a shell, a vibration plate, a back plate and a support elastic element, the shell includes a vibration cavity, which is equipped with a first opening end and a second opening end, and the vibration plate is movably set at the first opening end of the vibration cavity, the back plate is fixedly set at the second opening end of the vibration cavity, and is set at an interval opposite to the vibration plate, the support elastic element is located inside the vibration cavity, and the upper and lower ends of the support elastic element are elastically abutted between the vibration plate and the back plate, to drive the vibration plate to move along the axial direction of the vibration cavity, the vibration plate is made of rigid material, and only direct contact mechanical vibration can cause the vibration plate to vibrate.

### TECHNICAL FIELD

The present invention relates to the technical field of detection equipment, in particular to a vibration sensor and a dog bark detection device.

### BACKGROUND

Pet dog breeders generally encounter the phenomenon of uncontrollable barking of pet dogs. To deal with this situation, breeders usually use pet bark stoppers to stop pets from barking, but pet bark stoppers often rely on breeders to judge whether it is necessary to stop the pet dog from barking, so it is easy to make operational errors and cause the phenomenon of stopping the pet dog from barking when it is not necessary.

U.S. Pat. No. 4,947,795 discloses a bark control device and method. The bark control device detects sound through a microphone and analyzes dog barking through sound frequency and decibels, thereby achieving automatic electric shock bark stopping function. However, the elastic membrane in this vibration sensor is easily interfered by the external sound environment, especially when there are multiple pet dogs in a small range, it is easy to cause bark analysis failure, easily trigger its vibration, and thus trigger incorrect bark stopping.

U.S. Patent No. 20120048212 discloses a dog bark suppression device. The device includes a hanging device, which is equipped with a tuning fork. The tuning fork can swing freely with the device and can be swung by the dog's actions, such as those caused by barking. This causes the tuning fork to strike the inside of the device, causing the tuning fork to vibrate at its specific frequency and emit sound and vibration at that frequency. This emitted sound passes through the port to the dog's ears, thereby reducing the desire to bark and usually calming him down. However, this dog bark suppression device is easily interfered with by external factors, causing the device to make incorrect bark stopping judgments.

Therefore, it is necessary to provide a bark stopping device. This dog bark stopping device can shield the interference of external sounds, thereby improving the accuracy of the dog bark detection device monitoring, achieving accurate judgment of the dog bark detection device, and effectively preventing incorrect electric shock bark stopping situations.

### SUMMARY

The present invention provides a vibration sensor, comprising:
a shell, a vibration plate, a back plate, and a support elastic element, wherein
the shell includes a vibration cavity, which is equipped with a first opening end and a second opening end; and
the vibration plate is movably set at the first opening end of the vibration cavity; and
the back plate is fixedly set at the second opening end of the vibration cavity, and is set at an interval opposite to the vibration plate; and
the support elastic element is located inside the vibration cavity, and the upper and lower ends of the support elastic element are elastically abutted between the vibration plate and the back plate, to drive the vibration plate to move along the axial direction of the vibration cavity; and
wherein, the vibration plate is made of rigid material, and only direct contact mechanical vibration can cause the vibration plate to vibrate.

The present invention also provides a dog bark detection device, comprising:
a vibration sensor and a processing device, wherein
the vibration sensor includes a shell, a vibration plate, a back plate, and a support elastic element, the shell includes a vibration cavity, which is equipped with a first opening end and a second opening end, the vibration plate is movably set at the first opening end of the vibration cavity, the vibration plate is made of rigid material, including a connected insulation layer and conductive layer, the back plate is fixedly set at the second opening end of the vibration cavity and is set at an interval opposite to the vibration plate, the support elastic element is located inside the vibration cavity, the upper and lower ends of the support elastic element are elastically abutted between the vibration plate and the back plate to drive the vibration plate to move along the axial direction of the vibration cavity; and
the processing device includes a collection module, filtering module, signal amplification module, ad conversion module, and a programmable chip; and
wherein, the vibration plate is made of rigid material, and only direct contact mechanical vibration can cause the vibration plate to vibrate, w % ben the frequency and amplitude of mechanical vibration reach the set range value, it can trigger the bark stopping mechanism of the dog bark detection device, thereby realizing the bark stopping of pets by the dog bark detection device.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a sectional view of the vibration sensor applied for in this invention;

FIG. 2 is a structural block diagram of the dog bark detection device applied for in this invention.

In the drawings:

1, Shell; 2, Vibration Plate: 3, Back Plate; 4, Support Elastic Element; 101, First Opening End; 102, Second Opening End; 103, Vibration Cavity: 201, Insulation Layer; 202, Conductive Layer.

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference w % ill now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that people having ordinary skills in art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

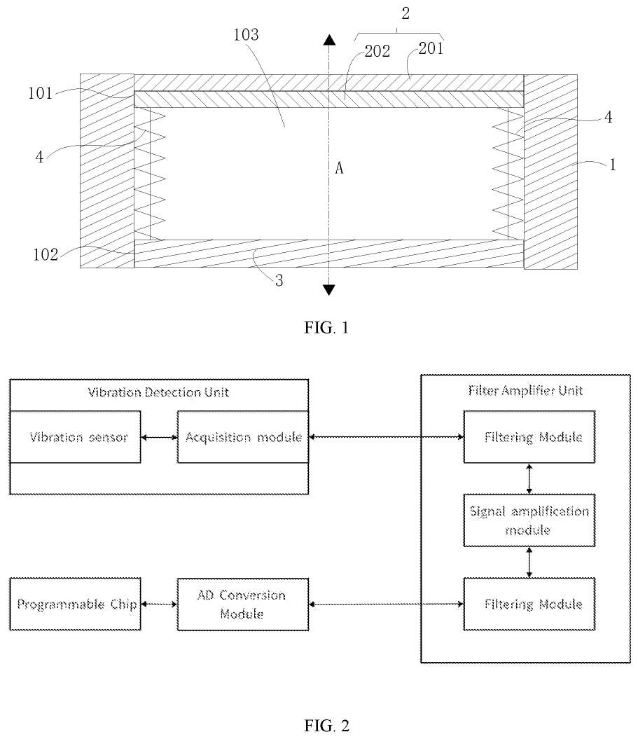

As a preferred embodiment of this invention, refer to FIG. 1, this invention provides a vibration sensor, including a shell 1, a vibration plate 2, a back plate 3, and a support elastic element 4.

In this embodiment, the shell 1 is a ring structure, its cross-sectional shape can be circular, elliptical or runway shaped. The runway shape is the shape of adding two semicircles at both ends of a rectangle. In some embodiments, the cross-sectional shape of the shell 1 can also be semicircular, or rectangular, or square, or triangular, and various other geometric shapes.

The shell 1 includes a vibration cavity 103, the vibration cavity 103 has a first opening end 101, and a second opening end 102. In this embodiment, the first opening end 101 and the second opening end 102 are respectively set at the upper and lower ends of the vibration cavity 103.

In other embodiments, the positions of the first opening end 101 and the second opening end 102 can be set at the left and right ends, or the front and back ends. As long as the first opening end 101 and the second opening end 102 are set at the opposite ends of the vibration cavity 103.

The vibration plate 2 can be movably set at the first opening end 101 of the vibration cavity 103. The vibration plate 2 can move relative to the vibration cavity 103. Its material is rigid, realizing that only direct mechanical vibration can cause the rigid vibration plate 2 to vibrate. In some embodiments, the material of the vibration plate 2 can be metal, or glass, or plastic, or polymer and other materials that are rigid and not easy to deform.

Vibration plate 2 is divided into two parts: upper and lower. Both connected parts are rigid plates. The upper and lower parts are respectively equipped with an insulation layer 201 and a conductive layer 202. The insulation layer 201 is located at one end far from the vibration cavity 103, that is, the upper part of the vibration plate 2. The conductive layer 202 is located at one end close to the vibration cavity 103, that is, the lower part of the vibration plate 2.

The back plate 3 is fixedly set at the second opening end 102 of the vibration cavity 103 and is spaced apart from the vibration plate 2. The back plate 3 cannot move relative to the vibration cavity 103. Its material is made of rigid conductive material. In some embodiments, the material of back plate 3 can be metal material, or alloy material, or graphite material, or conductive ceramic material.

It needs to be further explained that materials for back plate 3 are not limited to the above-mentioned materials structure. Those skilled in this field can flexibly adjust and set up materials for back plate 3 in actual applications as long as they can make materials for back plate 3 rigid conductive materials.

In this embodiment, the cross-sectional shape of the vibration plate 2 corresponds to the cross-sectional shape of the shell 1, which can be circular, elliptical, or runway shaped. The runway shape is the shape of adding two semicircles at both ends of a rectangle. The cross-sectional shape of the back plate 3 may not correspond to the cross-sectional shape of the shell 1, with the back plate 3 being set parallel to the shell 1. In some embodiments, such as when the precision requirement for the vibration sensor is not high or when the production level cannot meet the requirement, the back plate 3 may not be completely parallel to the shell 1, with their relative positions being nearly horizontal. The vibration plate 2 and back plate 3 constitute an adjustable capacitor. The up-and-down vibration of the vibration plate 2 changes the capacitance value of the adjustable capacitor. Through the change in capacitance value, the frequency and amplitude of mechanical vibration are analyzed. By comparing the obtained analysis value with the set range value, it can be judged whether pets are barking.

The support elastic element 4 is two in number, located in the vibration cavity 103, symmetrically distributed on the inner wall of the shell 1, and fits with the inner wall of the shell 1. The upper and lower ends of the support elastic element 4 are elastically abutted between the vibration plate 2 and the back plate 3 respectively. The support elastic element 4 is made of insulating material. In other embodiments, the support elastic element 4 can be configured as one or more other quantities.

Specifically, when a pet barks, the pet's throat emits sound, and the throat will cause the vibration plate 2 to vibrate. The vibration plate 2 is connected to the support elastic element 4. Under the action of elasticity, the support elastic element 4 will drive the vibration plate 2 to move along the axial direction of the vibration cavity 103 and reciprocate in the vertical direction. Therefore, the vibration sensor can receive vibration signals and then transmit them to the processor.

The structure of the vibration sensor in this invention application is similar to that of a capacitive microphone, but the vibration sensor of this invention application replaces the elastic vibration film in a capacitive microphone with a rigid vibration plate, thereby realizing that only direct mechanical vibration can cause rigid vibration plate to vibrate, and sound cannot effectively cause it to vibrate. Therefore, the vibration sensor of this invention application can shield external noise interference, thereby improving the accuracy of vibration reception and transmission.

As a preferred embodiment of this invention, in order to effectively stop pets from barking, refer to FIG. 2, this invention also provides a dog bark detection device, including a vibration sensor and a processing device, that is, on the basis of the above-mentioned vibration sensor, a processing device is added to achieve detection of pet dog barking.

The processing device is an electronic processing module, including a collection module, filtering module, signal amplification module, ad conversion module and programmable chip.

In this embodiment, the vibration sensor and vibration information collection module constitute a vibration detection unit. The vibration plate and back plate in the vibration sensor constitute a capacitor. The up-and-down vibration of the vibration plate will cause changes in this capacitor value. With the help of vibration information collection module, mechanical vibrations can be converted into electrical signals.

In this embodiment, various different vibration sensors can be used, including but not limited to accelerometers, optical devices, electromagnetic and capacitive sensors, contact devices, sensors, displacement sensors, piezoelectric sensors, pressure resistance devices, variable capacitors, servo devices, audio devices. The transmission of vibration can be gas, liquid or solid, including but not limited to microphones, seism phones and so on.

The filtering module and signal amplification module can filter and amplify the vibration electrical signal collected by the vibration sensor, filter out invalid signals and amplify valid signals, thereby greatly improving the recognition rate of dog barking.

The ad conversion module, also known as the analog-to-digital converter, converts analog signals into digital signals for further processing by the programmable chip.

The programmable chip performs specific program development to analyze the vibration frequency and amplitude of the vibration signal, thereby realizing the recognition of pet dog barking behavior and the analysis of barking decibels.

Specifically, in use, because the vibration plate is a rigid vibration plate, only direct mechanical vibration can cause the rigid vibration plate to vibrate, and sound cannot effectively cause it to vibrate. For example, when walking a dog in a park or on a street, you may encounter other dog groups. They may play or bark together. Other sensors such as microphones judge by sound. This will mistakenly regard other dog barks as the sound emitted by the target dog and trigger the bark stopping function. The vibration sensor of this invention application needs to judge directly contacted movements, which greatly improves accuracy.

In this embodiment, when worn, the dog bark detection device has corresponding wearables. The wearable is a detachable collar that is fixed to the pet's throat. The outer surface of the vibration plate on the vibration sensor is worn close to the position of the pet dog's neck near the throat. The outer surface of the vibration plate is in contact with the throat. Once the pet dog barks, the vibration sensor can generate continuous vibrations from the vibration plate. The collection module will then receive vibration information and convert mechanical vibrations into electrical signals through circuit conversion. The electrical signal will be transmitted to the filtering circuit module, which will filter out invalid signals from the electrical signal. Valid information is then transmitted to the amplifying circuit. The amplifying circuit module amplifies the valid signal, greatly improving the recognition rate of dog barking. Afterwards, through the ad conversion circuit module, analog signals are converted into digital signals, making it convenient for the programmable chip to further process the signal. The programmable chip, after specific program development, can analyze the vibration frequency and amplitude of the vibration signal, thereby realizing the recognition of pet dog barking behavior and the analysis of barking vibrations.

In some embodiments, the wearable can also be a foot cover. The foot cover has an opening at the upper end and is used to cover the pet's foot. The conductive electrode column is evenly distributed on the inner wall of the foot cover. In other embodiments, the wearable is a strap. The two ends of the strap are movably connected. The strap is used to wrap around and fix on the pet's limbs. The conductive electrode column is evenly distributed on the inner side of the strap. In other embodiments, the wearable is a chest and back coat. The two ends of the chest and back coat are movably connected. The chest and back coat are used to fix the pet's trunk. The conductive electrode column is evenly distributed on the inner side of the chest and back coat. The chest and back coat are detachably connected with a pull strap. A pull force sensor is set at the connection place of the pull strap and the chest and back coat. The pull force sensor is connected with the control mechanism for communication.

When a pet dog barks, the sound frequency has specificity, so it can exclude the vibration of the vibration plate on the vibration sensor caused by the pet dog's movement through vibration frequency analysis, thereby effectively improving its reliability in recognizing barking. When the vibration frequency reaches a set range value, there are evenly distributed conductive electrode columns on the inner side of the collar. The conductive electrode column communicates with the programmable chip. There is a conductive medium inside the conductive electrode column. The programmable chip will transmit electrical signals through the conductive medium of the conductive electrode column to the pet's body, causing muscle contraction and tremor in pets, thereby completing bark stopping behavior.

In other embodiments, communication between conductive electrode column and programmable chip can use any one of various communication standards, protocols and technologies, including but not limited to global system for mobile communications (GSM), enhanced data rates for GSM evolution (EDGE), high-speed downlink packet access (HSDPA), wideband code division multiple access (W-CDMA), code division multiple access (CDMA), time division multiple access (TDMA), BLUETOOTH®, wireless fidelity (WI-FI) (FOR EXAMPLE, IEEE802.11A, IEEE802.111B, IEEE802.11G AND/OR IEEE802.11N), voice over internet protocol (VOIP), WI-MAX, email protocols (for example, internet message access protocol (IMAP) and/or post office protocol (POP)), instant messaging (for example, extensible messaging and presence protocol (XMPP), session initiation protocol for instant messaging and presence leveraging extensions (SIMPLE) and/or instant messaging and presence service (IMPS)), short message service (SMS), or any other suitable communication protocol, including those still under development from submission date of this document.

Therefore, w % ben the frequency reaches a certain specificity, the dog bark detection device will stop the pet from barking. However, the dog bark detection device of this invention application is not necessarily aimed at barking, such as excitement, running, etc., can trigger the bark stopping function, as long as the vibration frequency reaches the preset frequency range can trigger the device bark stopping mechanism. In this embodiment, the way to stop barking is by electric shock. In some embodiments, the way to stop barking can be to make a beep sound, or to generate vibration and other ways.

In summary, the dog bark stopping device of this invention application can shield external noise interference, thereby improving the accuracy of the dog bark detection device monitoring. The dog bark detection device has the advantages of accurate judgment, strong anti-interference ability and high reliability. It can effectively prevent erroneous electric shock bark stopping situations.

In some embodiments, the applicable object of this invention's dog bark detection device is not limited to animal dogs. Animals other than dogs can also be used, such as cats, rabbits, chickens, or ducks, or geese and other animals. As long as they can make a sound, they can be suppressed by this invention's dog bark detection device.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. The headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might.” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. A vibration sensor, comprising:
a shell, a vibration plate, a back plate, and a support elastic element, wherein
said shell includes a vibration cavity, which is equipped with a first opening end and a second opening end; and
said vibration plate is movably set at said first opening end of said vibration cavity; and
said back plate is fixedly set at said second opening end of said vibration cavity, and is set at an interval opposite to said vibration plate; and
said support elastic element is located inside said vibration cavity, and the upper and lower ends of said support elastic element are elastically abutted between said vibration plate and said back plate, to drive said vibration plate to move along the axial direction of said vibration cavity; and
wherein, said vibration plate is made of rigid material, and only direct contact mechanical vibration can cause said vibration plate to vibrate.

2. The vibration sensor according to claim 1, wherein
said shell is a ring-shaped structure, and its cross-sectional shape is, for example, circular, elliptical, or runway shaped.

3. The vibration sensor according to claim 2, wherein
said first opening end and said second opening end are respectively located at the corresponding two ends of said vibration cavity.

4. The vibration sensor according to claim 3, wherein
the cross-sectional shape of said vibration plate corresponds to the cross-sectional shape of said shell and said back plate is set in a substantially parallel structure relative to said shell.

5. The vibration sensor according to claim 4, wherein
said vibration plate is composed of two parts of rigid plates, including a connected insulation layer and conductive layer.

6. The vibration sensor according to claim 5, wherein
said insulation layer is located at one end far from said vibration cavity, and said conductive layer is located at one end close to said vibration cavity.

7. The vibration sensor according to claim 6, wherein
said back plate is made of rigid conductive material.

8. The vibration sensor according to claim 7, wherein
said vibration plate and said back plate in said vibration sensor form an adjustable capacitor, and the up and down vibration of said vibration plate changes the capacitance value of the adjustable capacitor.

9. The vibration sensor according to claim 1, wherein
at least one elastic component is affixed to the inner wall of said shell.

10. The vibration sensor according to claim 9, wherein
said support elastic element is made of insulating material.

11. A dog bark detection device, comprising:
a vibration sensor and a processing device, wherein
said vibration sensor includes a shell, a vibration plate, a back plate, and a support elastic element, said shell includes a vibration cavity, which is equipped with a first opening end and a second opening end, said vibration plate is movably set at said first opening end of said vibration cavity, said vibration plate is made of rigid material, including a connected insulation layer and conductive layer, said back plate is fixedly set at said second opening end of said vibration cavity and is set at an interval opposite to said vibration plate, said support elastic element is located inside said vibration cavity, the upper and lower ends of said support elastic element are elastically abutted between said vibration plate and said back plate to drive said vibration plate to move along the axial direction of said vibration cavity; and
said processing device includes a collection module, filtering module, signal amplification module, ad conversion module, and a programmable chip; and
wherein, said vibration plate is made of rigid material, and only direct contact mechanical vibration can cause said vibration plate to vibrate, when the frequency and amplitude of mechanical vibration reach the set range value, it can trigger the bark stopping mechanism of said dog bark detection device, thereby realizing the bark stopping of pets by said dog bark detection device.

12. The dog bark detection device according to claim 11, wherein
said collection module converts the mechanical vibration signal in said vibration sensor into an electrical signal.

13. The dog bark detection device according to claim 12, wherein
said filtering module and said signal amplification module filter and amplify the electrical signal from said collection module, filtering out invalid information and amplifying valid information.

14. The dog bark detection device according to claim 13, wherein
said ad conversion module converts the analog signal into a digital signal.

15. The dog bark detection device according to claim 14, wherein
said programmable chip analyzes the vibration frequency and amplitude of the digital signal transmitted by said ad conversion module.

16. The dog bark detection device according to claim 15, wherein
said dog bark detection device also includes a wearable item and a conductive electrode column, said wearable item is used for wearing on the pet's body.

17. The dog bark detection device according to claim 16, wherein
said wearable item is a collar, both ends of said collar are movably connected, so that said collar is fixed on the pet's throat.

18. The dog bark detection device according to claim 17, wherein
said conductive electrode column communicates with said programmable chip and receives the electrical signal transmitted by said programmable chip.

19. The dog bark detection device according to claim 18, wherein
said conductive electrode columns are evenly distributed on the inner side of said collar.

20. The dog bark detection device according to claim 19, wherein
a conductive medium is set inside the conductive electrode column, so that the electrical signal is conducted to the pet's body through the conductive medium of said conductive electrode column and makes the pet's muscles contract and tremble.
